(19) United States
(12) Patent Application Publication
(10) Pub. No.: US 2024/0020253 A1
(43) Pub. Date: Jan. 18, 2024

(54) INSTRUCTION SET ARCHITECTURE SUPPORT FOR DATA TYPE CONVERSION IN NEAR-MEMORY DMA OPERATIONS

(71) Applicant: Intel Corporation, Santa Clara, CA (US)

(72) Inventors: Shruti Sharma, Beaverton, OR (US); Robert Pawlowski, Beaverton, OR (US); Fabio Checconi, Fremont, CA (US); Jesmin Jahan Tithi, San Jose, CA (US)

(21) Appl. No.: 18/477,787

(22) Filed: Sep. 29, 2023

(51) Int. Cl. G06F 13/28

(52) U.S. Cl. CPC G06F 13/28; G06F 2213/28

(57) ABSTRACT

Systems, apparatuses and methods may provide for technology that detects a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline, decodes the plurality of sub-instruction requests to identify one or more arguments, loads a source array from a dynamic random access memory (DRAM) in a plurality of DRAMs, wherein the operation engine is to correspond to the DRAM, and conducts a conversion of the source array from a first data type to a second data type in accordance with the one or more arguments.

### GOVERNMENT LICENSE RIGHTS

This invention was made with government support under W911NF22C0081-0107 awarded by the Office of the Director of National Intelligence—AGILE. The government has certain rights in the invention.

### TECHNICAL FIELD

Embodiments generally relate to direct memory access (DMA) operations. More particularly, embodiments relate to instruction set architecture (ISA) support for data type conversion in near-memory DMA operations.

### BACKGROUND

Recent developments may have been made in the use of bitmaps and a direct memory access (DMA) instruction set architecture (ISA) in artificial intelligence (AI) computations. These DMA solutions may require, however, data types to match before executing the DMA instruction.

### BRIEF DESCRIPTION OF THE DRAWINGS

The various advantages of the embodiments will become apparent to one skilled in the art by reading the following specification and appended claims, and by referencing the following drawings, in which:

FIG. 1A is a slice diagram of an example of a memory system according to an embodiment;

FIG. 1B is a tile diagram of an example of a memory system according to an embodiment;

FIG. 2 is a flowchart of an example of a method of operating a performance-enhanced memory system;

FIGS. 3 and 4 are flowcharts of examples of methods of conducting data type conversions according to embodiments;

FIG. 5 is a flowchart of an example of a more detailed method of operating a performance-enhanced memory system;

FIG. 6 is an illustration of an example of a conversion of a source array from a first data type to a second data type according to an embodiment;

FIG. 7 is an illustration of an example of a pseudocode listing to convert a source array from a first data type to a second data type according to an embodiment;

FIG. 8 is a block diagram of an example of a performance-enhanced computing system according to an embodiment;

FIG. 9 is an illustration of an example of a semiconductor package apparatus according to an embodiment;

FIG. 10 is a block diagram of an example of a processor according to an embodiment; and

FIG. 11 is a block diagram of an example of a multi-processor based computing system according to an embodiment.

### DETAILED DESCRIPTION

Data type conversion is a common operation found in many programs. For example, it is common to convert Brain 16-bit floating point (bfloat16) or 16-bit floating point (FP16) data types to a 32-bit floating point (FP32) data type as an optimization technique in many machine learning and deep learning model implementations. Indeed, FP32 is a common data type in deep learning and machine learning models, where activations, weights, and inputs are typically in FP32. Converting activations and weights to a lower precision such as 8-bit integer (INT8) is also an optimization technique. Similarly, a common conversion seen in many applications is FP32 to 64-bit floating point (FP64). The OPENVINO toolkit and many IEEE (Institute of Electrical and Electronic Engineers) standards support these functionalities and data types.

For the conversion process itself, the goal is to map the range of the source to the range of the destination type. Traditionally, central processing unit (CPU) or graphics processing unit (GPU) cores are used to perform the conversion. The technology described herein uses direct memory access (DMA) operations to perform the same operations using an enhanced DMA engine. Although the cost of type conversion might not be the most time-consuming operation compared to others (e.g., convolution or double precision general matrix multiplication/DGEMM) when using CPU/GPU, in use case scenarios where most of the operations can be offloaded to a DMA engine, not having a DMA engine supported type conversion can become a bottleneck. Additionally, having a DMA-supported type conversion also frees up the CPU/GPU pipelines to perform other operations while type conversion occurs asynchronously in parallel using an enhanced DMA engine.

Embodiments detail an instruction set architecture (ISA) and architectural support for a remote DMA operation that executes a data type conversion of source data using near-memory compute hardware. The converted source values are then operated on with destination array values (e.g., near the destination memory) and stored back into the destination array. This full operation can be offloaded from the main core pipeline and will execute in the background after being initiated by just a single instruction. Providing entire type conversion operations as an ISA enables improved software efficiency. Additionally, by utilizing near-memory compute and sending the source data directly to the destination array location, total latency may be reduced (e.g., when applied to a large-scale distributed memory system) compared to an implementation using only the resources of the core-pipeline.

A memory system (e.g., Transactional Integrated Global-memory system with Dynamic Routing and End-to-end flow control/TIGRE) as described herein has the capability of performing DMA operations designed to address common data movement primitives used in graph algorithms. Data movement is allowed across all memory endpoints visible via a 64-bit Global Address Space (GAS) address map. Storage in the TIGRE system includes a static random access memory (SRAM) scratchpad shared across eight pipelines in a TIGRE slice and sixteen DRAM channels that are part of a TIGRE tile. As the system scales out, multiple tiles comprise a TIGRE socket, and the socket count increases to expand the full system.

TIGRE implements DMA data type conversion for converting data from source array to a different representation in an output array. DMA data type conversion allows converting between signed data type, two's complement representations, 4-bit integer (INT4) representations and floating-point representations. Implementing DMA data type conversion involves a system of DMA engines including pipeline-local memory Engines (MENGs) and near memory Operation Engines (OPENGs) at all memory endpoints in the system. An optional atomic operation can be applied at the destination address to each data item, in which case an atomic unit (ATMU) is used.

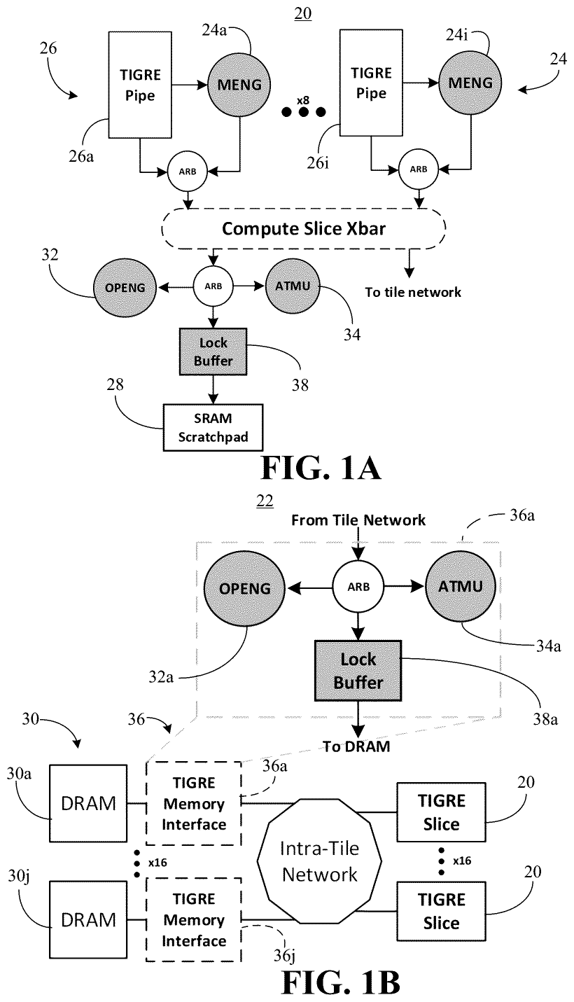

Turning now to FIGS. 1A and 1B, a TIGRE slice 20 diagram and a TIGRE tile 22 diagram are shown, respectively. FIGS. 1A and 1B show the lowest levels of the hierarchy of the TIGRE system. More particularly, the TIGRE slice 20 includes a plurality of memory engines 24 (24a-24i) corresponding to a plurality of pipelines 26 (26a-26i), wherein each memory engine 24 is adjacent to a pipeline in the plurality of pipelines 26. Each TIGRE pipeline 26 offloads DMA operations (e.g., exposed in the ISA) to a local memory engine 24 (MENG). In the illustrated example, eight of the TIGRE pipelines 26 are co-located with a shared cache (not shown) and a local SRAM scratchpad 28 to create the TIGRE slice 20. The illustrated TIGRE tile 22 includes eight slices 20—e.g., sixty-four pipelines 26 and sixteen local DRAM channels 30 (30a-30j). Specifically, the DMA subsystem hardware is made of up units that are local to the pipeline 26 as well as in front of all scratchpad 28 and DRAM channel 30 interfaces.

Atomic units 34 (e.g., 34a-34j, not shown, e.g., ATMUs) are positioned adjacent to scratchpad 28 and memory interfaces 36, and handle the compute and read-lock/write-unlock functionality remote atomic operations. Requests can be sent to the ATMUs 34 directly by the pipelines 26 or by the memory engines 24. The ATMUs 34 include an integer and floating-point computation unit, as well as a local load-store buffer to support parallel execution of instructions while also maintaining high throughput atomic read-write requests to the DRAM channels 30.

The memory engines 24 (MENGs) receive DMA bitmap requests from the local pipelines 26 and initiate the operation. For example, a first MENG 24a is responsible for requesting one or more DMA data type conversion operations associated with a first pipeline 26a. Thus, the first MENG 24a sends out remote load-stores, direct or indirect, with or without an atomic operation. The first MENG 24a also tracks the remote load stores sent and waits for all the responses to return before sending a final response back to the first pipeline 26a.

Operation engines 32 (32a-32j, not shown, e.g., OPENGs) are positioned adjacent to memory interfaces 36 (36a-36j) and receive the load-store requests from the MENGs 24. The OPENGs 32 are responsible for performing the actual memory load-store, converting the data type, and sending a follow-on load/store or atomic request if appropriate. Details pertaining to the role of the OPENGs 32 in the DMA bitmap manipulation operations are provided below.

Lock buffers 38 (38a-38j, not shown) are positioned in front of the memory port and maintain line-lock statuses for memory addresses. Each lock buffer 38 is a multi-entry buffer that allows for multiple locked addresses in parallel per memory interface 36, supports 64byte (B) or 8B requests, handles partial line updates and write-combining for partial stores, and supports “read-lock” and “write-unlock” requests within atomic operations (“atomics”). The lock buffers 38 double as a small cache to allow fast access to memory data for bitmap manipulation operations.

### DMA Convert ISA and Pipeline Support

Table I lists the DMA data type conversion instruction included as part of the TIGRE ISA. The instruction is issued from the pipeline 26 to a respective local MENG 24 and includes the source address information, destination address information, count value and DMA_Type. DMA_type contains information on the conversion type and atomic opcode. The MENG 24 uses the OPENG 32 positioned adjacent to the source and destination memory locations to complete the DMA operation. If an atomic operation is requested on the destination data, the 32 OPENG sends a request to the ATMU 34 to perform the atomic operation on each data item.

TABLE I

| Instruction | Assembly Code for Arguments |
|---|---|
| Dma.convert | R1, r2, r3, DMA_type, SIZE |
| (DMA data type | R1 = Destination Address |
| conversion) | R2 = Source Address |
| | R3 = Count |
| | DMA_type = atomic opcode, optype, |
| | convert type information |

The DMA data type conversion instruction supports the following data type representations: signed integer, floating point, two's complement and int4 representation. For signed integer and two's complement representations, conversion is supported for the following data sizes: eight bits, sixteen bits, thirty-two bits and sixty-four bits. For floating point representation, the supported data sizes are sixteen bits, thirty-two bits, and sixty-four bits. Int4 only supports 4-bit data size. Type conversion is supported for all of the data types and valid data sizes listed above. Type conversion is also allowed between the same data type with a different size. For float to integer conversion (signed or two's complement form), the “integer” value is taken, and the decimal value is ignored (e.g., discarded). To convert any of the data types to the “INT4” representation, the technology described herein identifies the “integer” part of the data and takes the four most significant bits (MSBs) from the integer value. For data type conversions where an out-of-range-data error occurs, the OPENG 32 sends an error response to the MENG 24 and the destination memory will not be updated.

DMA Data Type Conversion Operation

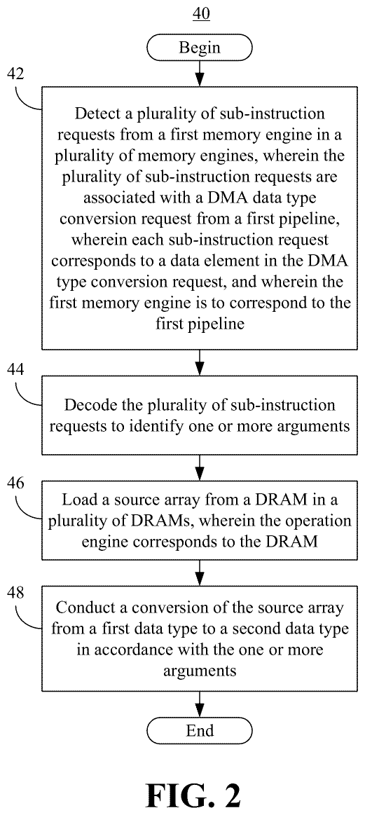

FIG. 2 shows a method 40 of operating a performance-enhanced memory system. The method 40 may generally be implemented in an operation engine such as, for example, the operation engine 32 (FIG. 1A), already discussed. More particularly, the method 40 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 40 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 42 detects a plurality of sub-instruction requests from a first memory engine in a plurality of memory engines, wherein the plurality of sub-instruction requests are associated with a DMA data type conversion request from a first pipeline. Each sub-instruction request corresponds to a data element in the DMA data type conversion request and the first memory engine corresponds to the first pipeline. Block 44 decodes the plurality of sub-instruction requests to identify one or more arguments. Block 46 loads a source array from a DRAM in a plurality of DRAMs, wherein the operation engine corresponds to the DRAM. Additionally, block 48 conducts a conversion of the source array from a first data type to a second data type in accordance with the one or more arguments.

The method 40 therefore enhances performance at least to the extent that providing the entire DMA type conversion request as an ISA enables improved software efficiency. Additionally, by using near-memory compute and sending the source array directly to the destination array location, total latency is reduced (e.g., when applied to a large-scale distributed memory system) compared to an implementation using only the resources of the core pipeline.

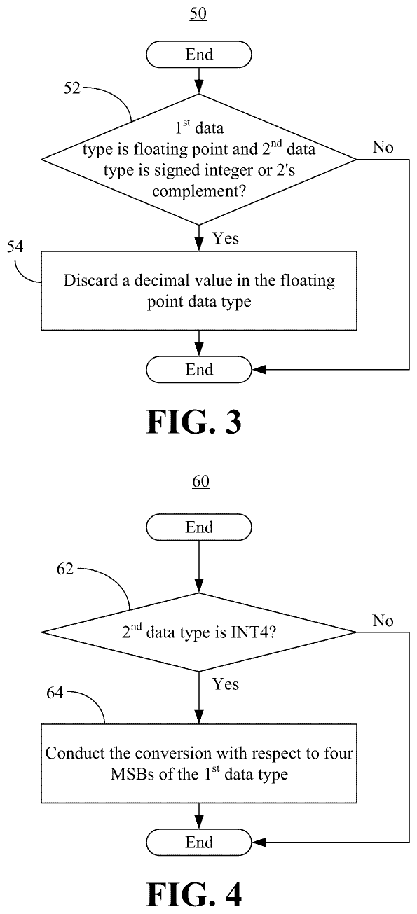

FIG. 3 shows a method 50 of conducting data type conversions. The method 50 may generally be incorporated into block 48 (FIG. 2), already discussed. More particularly, the method 50 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 52 determines whether the first data type includes a floating point data type and the second data type includes one of the signed integer data type or the two's complement data type. If so, block 54 discards a decimal value in the floating point data type. Otherwise, the method 50 bypasses block 54 and terminates.

FIG. 4 shows another method 60 of conducting data type conversions. The method 60 may generally be incorporated into block 48 (FIG. 2), already discussed. More particularly, the method 60 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 62 determines whether the second data type includes the INT4 data type. If so, block 64 conducts the conversion with respect to the four MSBs of the first data type integer portion. Otherwise, the method 60 bypasses block 64 and terminates.

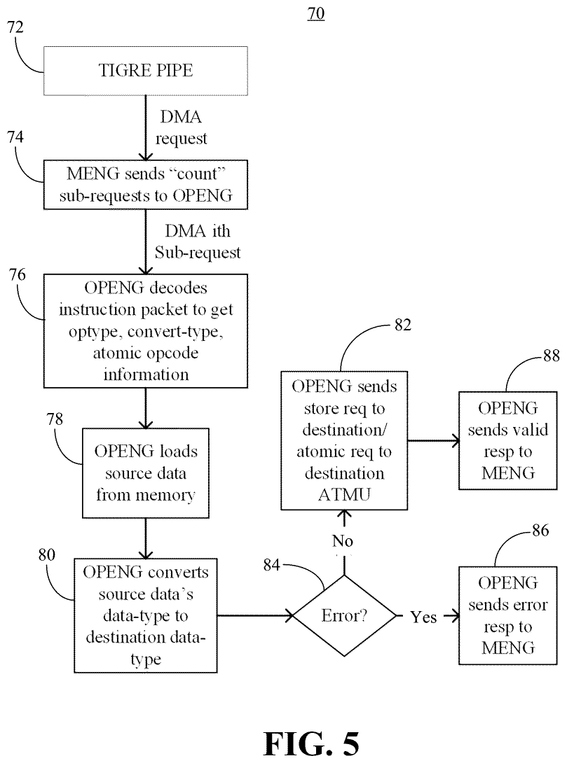

FIG. 5 shows a more detailed method 70 of operating a performance-enhanced memory system. The method 70 may generally be implemented in the TIGRE slice 20 (FIG. 1A) and/or the TIGRE tile 22 (FIG. 1B), already discussed. More particularly, the method 70 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

As already noted, the DMA subsystem includes a pipeline-local MENG and near-memory OPENG, with optional use of the ATMU 34 perform the atomic operation on destination data. A description of the responsibilities of each unit in executing the operation is as follows:

The MENG receives the DMA instructions from the local pipeline 72, stores the instruction information into a local buffer slot, and sends out “count” number of sub-instruction request packets (e.g., one sub-instruction request per data element) each to a remote OPENG in block 74. Each packet sent by the MENG includes source and destination address information, atomic opcode information, and convert type information (e.g., arguments). After sending “count” number of sub-instructions out to the OPENG, the MENG waits for “count” number of responses. Once the MENG receives all the responses back, the MENG sends a final response back to the pipeline 72 and the instruction is considered as complete.

The OPENG receives multiple requests from the MENG describing the operation to be performed and decodes the instruction packet at block 76. For DMA data type conversion instructions, the OPENG loads the data from source memory at block 78, converts the data type to match the destination data type at block 80. If it is determined at block 84 that the conversion has resulted in a completion condition, the OPENG creates and sends a store request to the destination memory with the converted data at block 82, and sends a valid response to the MENG at block 88. The data type conversion therefore occurs internally in the OPENG. If it is determined at block 84 that the type conversion has resulted in an out-of-range error condition, the OPENG sends an error notification/response to the MENG at block 86 without updating the destination memory. For instructions requiring atomic operations, the OPENG sends requests to the ATMU at block 82 with the destination address information, data value and opcode type.

The ATMU receives the atomic instruction from OPENG if an atomic operation is to be conducted at the destination. The ATMU performs the atomic operation by sending the read-lock and write-unlock instructions to memory. All ATMU accesses to memory are handled by the cached locked buffer positioned next to memory interface. The Lock Buffer locks an address when a locked-read request is received from the ATMU. The address is locked until the ATMU sends an unlock-write request for the same address. Once the ATMU completes the operation, the ATMU sends a response packet back to the MENG.

Conversion Details

dma.convert r1, r2, r3, DMA_type, SIZE

R1=Destination Address, R2=Source Address, R3=Count

The dma.convert instruction converts data from the source array to match the data-type of elements in the destination array. An optional atomic operation can be applied at destination to each data item.

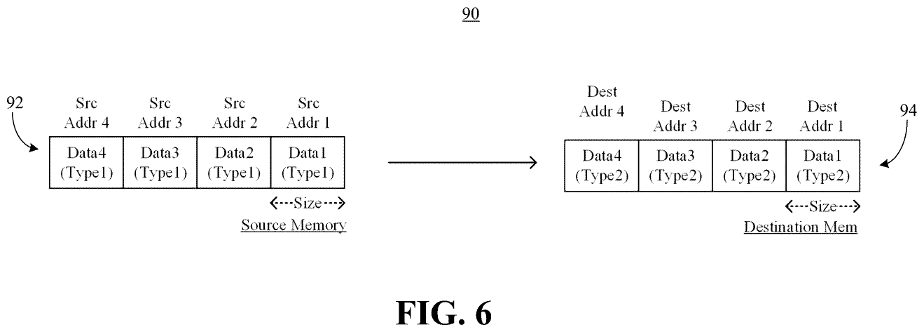

FIG. 6 shows an example of the dma.convert operation 90. This example converts a source array 92 of four data elements (count=4) with starting address as source address, and data-type as type1. The data-type of the elements is converted to destination data-type (type2) and stored in four contiguous locations with base address given by destination address 94 (e.g., destination array). The atomic opcode in this example is taken as “NONE”, so the converted data is copied to the destination array without any additional operation. If an atomic opcode is specified in the instruction, the corresponding operation is performed between the converted data value and the pre-existing data value at the respective location in the destination array.

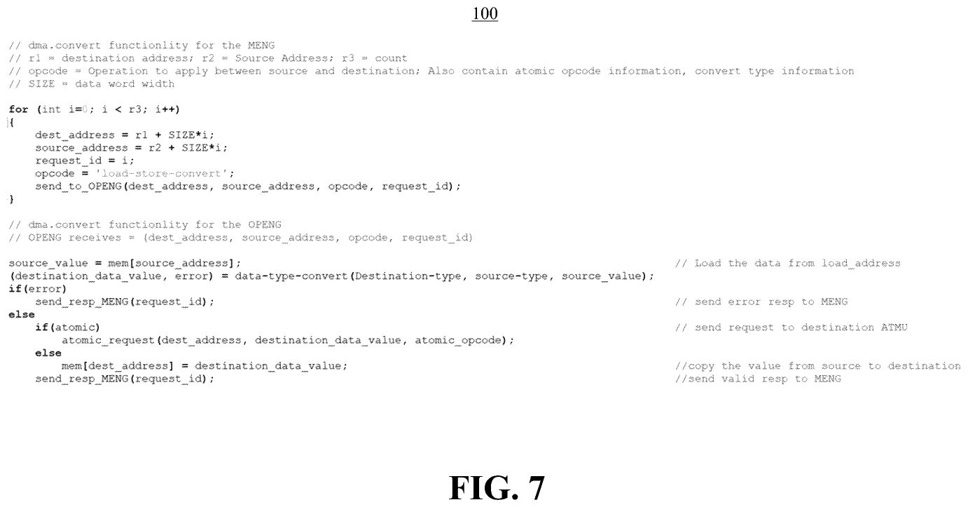

FIG. 7 shows a pseudocode listing 100 describing the functionality of both the MENG and OPENG while executing the dma.convert instruction. The MENG sends “count”(r3) number of sub-instruction-reqs to the OPENG. Each of the instruction request packets contains the source address information, destination address information, opcode information, atomic-opcode information, source data-type and destination data-type. For each sub-instruction, the OPENG loads the source data value from source address, converts the data-type representation from source data-type to destination data-type, and executes a store/atomic to the destination address. If an error occurs while converting the source data-type to destination data-type, the OPENG sends an error response to MENG without performing the final store/atomic. The physical locations of the arrays in the system may vary, meaning that the sequence of operations shown for the OPENG may be executed by multiple physical OPENG units (e.g., each local to their respective data structures).

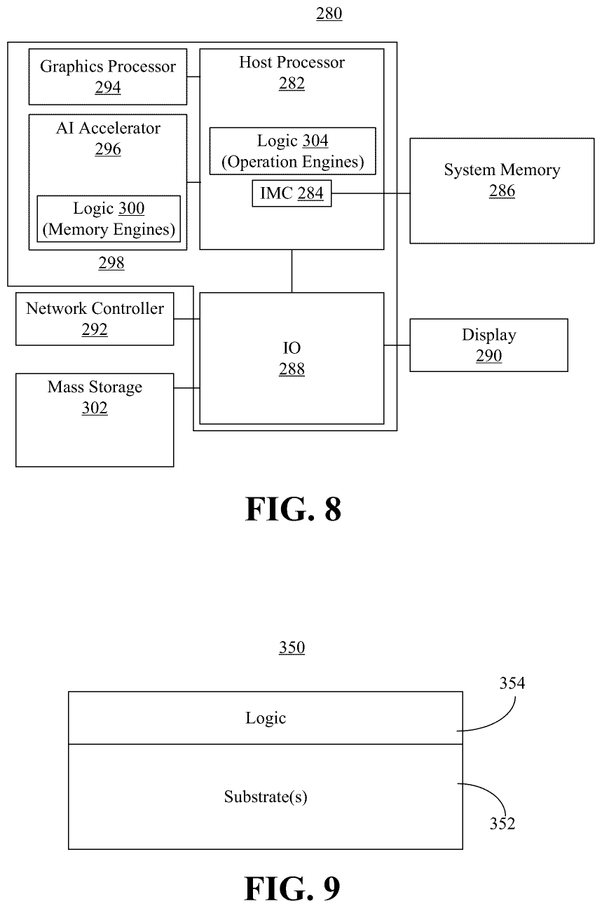

Turning now to FIG. 8, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 includes memory engine logic 300 and the host processor 282 includes operation engine logic 304, wherein the logic 300, 304 represents a performance-enhanced memory system. The operation engine logic 304 performs one or more aspects of the method 40 (FIG. 2), the method 50 (FIG. 3), the method 60 (FIG. 4) and/or the method 70 (FIG. 5), already discussed. Thus, an operation engine in the operation engine logic 304 (e.g., including a plurality of operation engines) detects a plurality of sub-instruction requests from a first memory engine in the memory engine logic 300 (e.g., including a plurality of memory engines), wherein the plurality of sub-instruction requests are associated with a DMA type conversion request from a first pipeline. Each sub-instruction request corresponds to a data element in the DMA data type conversion request and the first memory engine corresponds to the first pipeline. The operation engine also decodes the plurality of sub-instruction requests to identify one or more arguments, loads a source array from a DRAM in the system memory 286, wherein the operation engine corresponds to the DRAM, and conducts a conversion of the source array from a first data type to a second data type in accordance with the argument(s).

The memory system is therefore considered performance-enhanced at least to the extent that providing the entire DMA type conversion request as an ISA enables improved software efficiency. Additionally, by using near-memory compute and sending the source array directly to the destination array location, total latency is reduced (e.g., when applied to a large-scale distributed memory system) compared to an implementation using only the resources of the core pipeline.

FIG. 9 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. The logic 354 can be readily substituted for the logic 300, 304 (FIG. 8), already discussed. In an embodiment, the logic 354 implements one or more aspects of the method 40 (FIG. 2), the method 50 (FIG. 3), the method 60 (FIG. 4) and/or the method 70 (FIG. 5), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

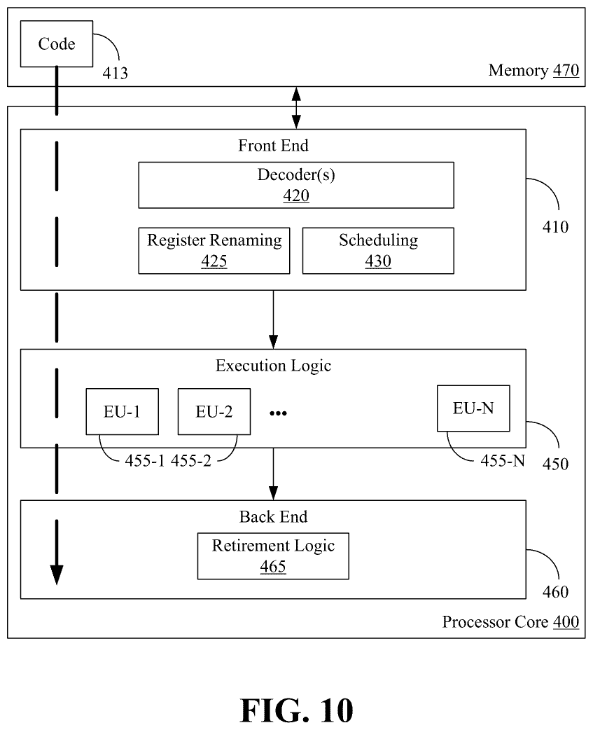

FIG. 10 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 10, a processing element may alternatively include more than one of the processor core 400 illustrated in FIG. 10. The processor core 400 may be a single-threaded core or, for at least one embodiment, the processor core 400 may be multithreaded in that it may include more than one hardware thread context (or “logical processor”) per core.

FIG. 10 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 40 (FIG. 2), the method 50 (FIG. 3), the method 60 (FIG. 4) and/or the method 70 (FIG. 5), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 10, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

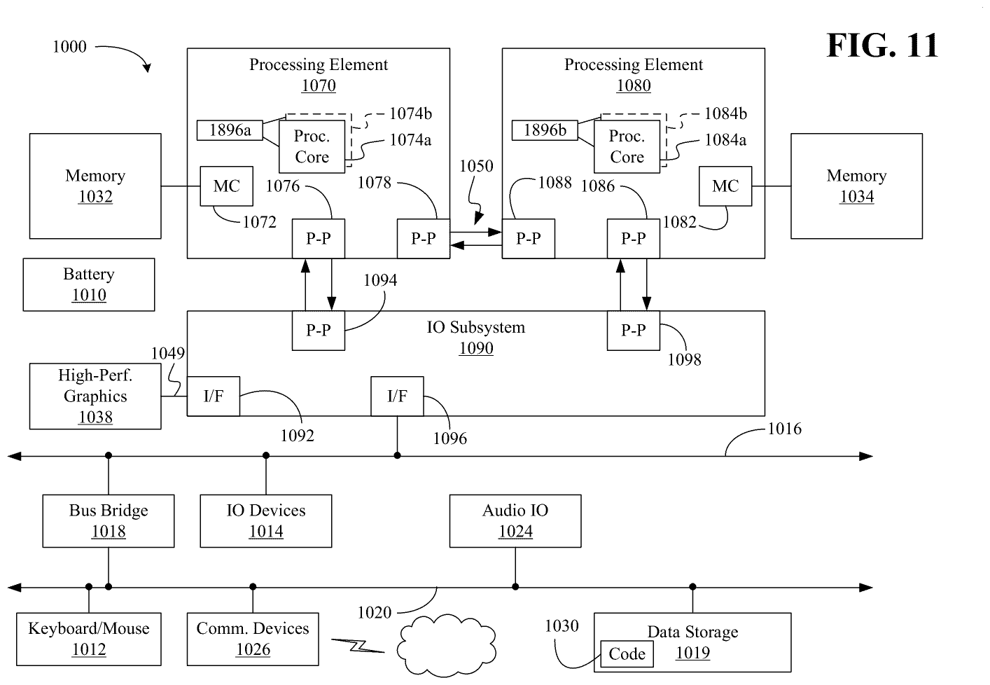

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 40 (FIG. 2), the method 50 (FIG. 3), the method 60 (FIG. 4) and/or the method 70 (FIG. 5), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### Additional Notes and Examples

Example 1 includes a performance-enhanced computing system comprising a network controller, a plurality of dynamic random access memories (DRAMs), and a processor coupled to the network controller, wherein the processor includes logic coupled to one or more substrates, the logic including an operation engine to detect a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline, decode the plurality of sub-instruction requests to identify one or more arguments, load a source array from a DRAM in the plurality of DRAMs, wherein the operation engine is to correspond to the DRAM, and conduct a conversion of the source array from a first data type to a second data type in accordance with the one or more arguments.

Example 2 includes the computing system of Example 1, wherein the operation engine is further to determine whether the conversion has resulted in an error condition or a completion condition, and send an error notification to the first memory engine if the conversion has resulted in the error condition.

Example 3 includes the computing system of Example 2, wherein the operation engine is further to store a result of the conversion to the DRAM as a destination array if the conversion has resulted in the completion condition, and send a valid response to the first memory engine.

Example 4 includes the computing system of Example 2, wherein the operation engine is further to issue a result of the conversion and an atomic request to an atomic unit if the conversion has resulted in the completion condition and the one or more arguments include an atomic opcode, and send a valid response to the first memory engine.

Example 5 includes the computing system of any one of Examples 1 to 4, wherein the first data type and the second data type are to include one or more of a floating point data type, a four-bit integer (INT4) data type, a signed integer data type or a two's complement data type.

Example 6 includes at least one computer readable storage medium comprising a set of executable program instructions, which when executed by an operation engine, cause the operation engine to detect a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline, decode the plurality of sub-instruction requests to identify one or more arguments, load a source array from a dynamic random access memory (DRAM) in a plurality of DRAMs, wherein the operation engine is to correspond to the DRAM, and conduct a conversion of the source array from a first data type to a second data type in accordance with the one or more arguments.

Example 7 includes the at least one computer readable storage medium of Example 6, wherein the executable program instructions, when executed, further cause the computing system to determine whether the conversion has resulted in an error condition or a completion condition, and send an error notification to the first memory engine if the conversion has resulted in the error condition.

Example 8 includes the at least one computer readable storage medium of Example 7, wherein the executable program instructions, when executed, further cause the computing system to store a result of the conversion to the DRAM as a destination array if the conversion has resulted in the completion condition, and send a valid response to the first memory engine.

Example 9 includes the at least one computer readable storage medium of Example 7, wherein the executable program instructions, when executed, further cause the computing system to issue a result of the conversion and an atomic request to an atomic unit if the conversion has resulted in the completion condition and the one or more arguments include an atomic opcode, and send a valid response to the first memory engine.

Example 10 includes the at least one computer readable storage medium of any one of Examples 6 to 9, wherein the first data type and the second data type are to include one or more of a floating point data type, a four-bit integer (INT4) data type, a signed integer data type or a two's complement data type.

Example 11 includes the at least one computer readable storage medium of Example 10, wherein if the first data type includes the floating point data type and the second data type includes one of the signed integer data type or the two's complement data type, the executable program instructions, when executed, cause the computing system to discard a decimal value in the floating point data type.

Example 12 includes the at least one computer readable storage medium of Example 10, wherein if the second data type includes the INT4 data type, the conversion is conducted with respect to four most significant bits of the first data type.

Example 13 includes a semiconductor apparatus comprising one or more substrates, and logic coupled to the one or more substrates, wherein the logic includes an operation engine implemented at least partly in one or more of configurable or fixed-functionality hardware, the operation engine to detect a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline, decode the plurality of sub-instruction requests to identify one or more arguments, load a source array from a dynamic random access memory (DRAM) in a plurality of DRAMs, wherein the operation engine is to correspond to the DRAM, and conduct a conversion of the source array from a first data type to a second data type in accordance with the one or more arguments.

Example 14 includes the semiconductor apparatus of Example 13, wherein the operation engine is further to determine whether the conversion has resulted in an error condition or a completion condition, and send an error notification to the first memory engine if the conversion has resulted in the error condition.

Example 15 includes the semiconductor apparatus of Example 14, wherein the operation engine is further to store a result of the conversion to the DRAM as a destination array if the conversion has resulted in the completion condition, and send a valid response to the first memory engine.

Example 16 includes the semiconductor apparatus of Example 14, wherein the operation engine is further to issue a result of the conversion and an atomic request to an atomic unit if the conversion has resulted in the completion condition and the one or more arguments include an atomic opcode, and send a valid response to the first memory engine.

Example 17 includes the semiconductor apparatus of any one of Examples 13 to 16, wherein the first data type and the second data type are to include one or more of a floating point data type, a four-bit integer (INT4) data type, a signed integer data type or a two's complement data type.

Example 18 includes the semiconductor apparatus of Example 17, wherein if the first data type includes the floating point data type and the second data type includes one of the signed integer data type or the two's complement data type, the operation engine is to discard a decimal value in the floating point data type.

Example 19 includes the semiconductor apparatus of Example 17, wherein if the second data type includes the INT4 data type, the conversion is conducted with respect to four most significant bits of the first data type.

Example 20 includes the semiconductor apparatus of any one of Examples 13 to 16, wherein the logic coupled to the one or more substrates includes transistor channel regions that are positioned within the one or more substrates.

Example 21 includes a method of operating a performance-enhanced computing system, the method comprising detecting a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline, decoding the plurality of sub-instruction requests to identify one or more arguments, loading a source array from a dynamic random access memory (DRAM) in a plurality of DRAMs, wherein the operation engine is to correspond to the DRAM, and conducting a conversion of the source array from a first data type to a second data type in accordance with the one or more arguments.

Example 22 includes an apparatus comprising means for performing the method of Example 21.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a plurality of dynamic random access memories (DRAMs); and
a processor coupled to the network controller, wherein the processor includes logic coupled to one or more substrates, the logic including an operation engine to:
detect a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline,
decode the plurality of sub-instruction requests to identify one or more arguments,
load a source array from a DRAM in the plurality of DRAMs, wherein the operation engine is to correspond to the DRAM, and
conduct a conversion of the source array from a first data type to a second data type in accordance with the one or more arguments.

2. The computing system of claim 1, wherein the operation engine is further to:
determine whether the conversion has resulted in an error condition or a completion condition, and
send an error notification to the first memory engine if the conversion has resulted in the error condition.

3. The computing system of claim 2, wherein the operation engine is further to:
store a result of the conversion to the DRAM as a destination array if the conversion has resulted in the completion condition, and
send a valid response to the first memory engine.

4. The computing system of claim 2, wherein the operation engine is further to:
issue a result of the conversion and an atomic request to an atomic unit if the conversion has resulted in the completion condition and the one or more arguments include an atomic opcode, and
send a valid response to the first memory engine.

5. The computing system of claim 1, wherein the first data type and the second data type are to include one or more of a floating point data type, a four-bit integer (INT4) data type, a signed integer data type or a two's complement data type.

6. At least one computer readable storage medium comprising a set of executable program instructions, which when executed by an operation engine, cause the operation engine to:
detect a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline;
decode the plurality of sub-instruction requests to identify one or more arguments;
load a source array from a dynamic random access memory (DRAM) in a plurality of DRAMs, wherein the operation engine is to correspond to the DRAM; and
conduct a conversion of the source array from a first data type to a second data type in accordance with the one or more arguments.

7. The at least one computer readable storage medium of claim 6, wherein the executable program instructions, when executed, further cause the computing system to:
determine whether the conversion has resulted in an error condition or a completion condition; and
send an error notification to the first memory engine if the conversion has resulted in the error condition.

8. The at least one computer readable storage medium of claim 7, wherein the executable program instructions, when executed, further cause the computing system to:
store a result of the conversion to the DRAM as a destination array if the conversion has resulted in the completion condition; and
send a valid response to the first memory engine.

9. The at least one computer readable storage medium of claim 7, wherein the executable program instructions, when executed, further cause the computing system to:
issue a result of the conversion and an atomic request to an atomic unit if the conversion has resulted in the completion condition and the one or more arguments include an atomic opcode; and
send a valid response to the first memory engine.

10. The at least one computer readable storage medium of claim 6, wherein the first data type and the second data type are to include one or more of a floating point data type, a four-bit integer (INT4) data type, a signed integer data type or a two's complement data type.

11. The at least one computer readable storage medium of claim 10, wherein if the first data type includes the floating point data type and the second data type includes one of the signed integer data type or the two's complement data type, the executable program instructions, when executed, cause the computing system to discard a decimal value in the floating point data type.

12. The at least one computer readable storage medium of claim 10, wherein if the second data type includes the INT4 data type, the conversion is conducted with respect to four most significant bits of the first data type.

13. A semiconductor apparatus comprising:
one or more substrates; and
logic coupled to the one or more substrates, wherein the logic includes an operation engine implemented at least partly in one or more of configurable or fixed-functionality hardware, the operation engine to:
detect a plurality of sub-instruction requests from a first memory engine in a plurality of memory engines, wherein the plurality of sub-instruction requests are associated with a direct memory access (DMA) data type conversion request from a first pipeline, wherein each sub-instruction request corresponds to a data element in the DMA data type conversion request, and wherein the first memory engine is to correspond to the first pipeline;
decode the plurality of sub-instruction requests to identify one or more arguments;
load a source array from a dynamic random access memory (DRAM) in a plurality of DRAMs, wherein the operation engine is to correspond to the DRAM; and
conduct a conversion of the source array from a first data type to a second data type in accordance with the one or more arguments.

14. The semiconductor apparatus of claim 13, wherein the operation engine is further to:
determine whether the conversion has resulted in an error condition or a completion condition; and
send an error notification to the first memory engine if the conversion has resulted in the error condition.

15. The semiconductor apparatus of claim 14, wherein the operation engine is further to:
store a result of the conversion to the DRAM as a destination array if the conversion has resulted in the completion condition; and
send a valid response to the first memory engine.

16. The semiconductor apparatus of claim 14, wherein the operation engine is further to:
issue a result of the conversion and an atomic request to an atomic unit if the conversion has resulted in the completion condition and the one or more arguments include an atomic opcode; and
send a valid response to the first memory engine.

17. The semiconductor apparatus of claim 13, wherein the first data type and the second data type are to include one or more of a floating point data type, a four-bit integer (INT4) data type, a signed integer data type or a two's complement data type.

18. The semiconductor apparatus of claim 17, wherein if the first data type includes the floating point data type and the second data type includes one of the signed integer data type or the two's complement data type, the operation engine is to discard a decimal value in the floating point data type.

19. The semiconductor apparatus of claim 17, wherein if the second data type includes the INT4 data type, the conversion is conducted with respect to four most significant bits of the first data type.

20. The semiconductor apparatus of claim 13, wherein the logic coupled to the one or more substrates includes transistor channel regions that are positioned within the one or more substrates.
